(19) United States
(12) Patent Application Publication
(10) Pub. No.: US 2026/0350751 A1
(43) Pub. Date: Nov. 5, 2026

(54) IMAGE SPLICING METHOD AND IMAGE PROCESSING DEVICE

(71) Applicant: Materials Analysis Technology Inc., Hsinchu County (TW)

(72) Inventors: Te-Chun Liu, Hsinchu County (TW); Hui-Ling Yen, Taoyuan City (TW); Hung-Jen Chen, Hsinchu City (TW)

(73) Assignee: Materials Analysis Technology Inc., Hsinchu County (TW)

(21) Appl. No.: 19/203,118

(22) Filed: May 8, 2025

(30) Foreign Application Priority Data
Apr. 22, 2025 (TW) 114115161

(51) Int. Cl. G06T 5/50; G06T 7/12; G06T 7/33; G06T 11/60

(52) U.S. Cl. CPC G06T 5/50; G06T 7/12; G06T 7/337; G06T 11/60; G06T 2207/20016; G06T 2207/20212

(57) ABSTRACT

Provided are an image splicing method and an image processing device. The method includes: multiple images to be spliced are obtained; the images to be spliced include at least one image row; a horizontal splicing procedure is performed on the images to be spliced in each image row to generate at least one first horizontal image corresponding to the at least one image row; the at least one first horizontal image is spliced into a first global image; a corresponding first image feature is identified in each first horizontal image in the first global image, and the at least one first horizontal image is accordingly calibrated into at least one corresponding second horizontal image; the at least one second horizontal image is spliced into a second global image; and a position of multiple edge images in the second global image is adjusted to generate a third global image.

### CROSS-REFERENCE TO RELATED APPLICATION

This application claims the priority benefit of Taiwan application serial no. 114115161, filed on Apr. 22, 2025. The entirety of the above-mentioned patent application is hereby incorporated by reference herein and made a part of this specification.

### BACKGROUND

### Technical Field

The disclosure relates to an image processing mechanism, and particularly relates to an image splicing method and an image processing device.

### Related Art

With the popularization of advanced instruments and automated equipment, in various fields such as scientific research, production processes, and quality inspection, it is often needed to perform multi-angular or partitioned photography on large objects or entire mechanisms through a camera device to obtain complete image information. However, due to limitations of viewing angle and resolution of the photography equipment, it is not possible to directly obtain a single high-resolution image covering the entire appearance. Therefore, multiple local images need to be post-processed and spliced to restore a complete view of the original object.

Currently, image splicing methods commonly seen in practice mostly rely on manual operations. Users need to load images one by one through image processing software, manually align and adjust overlapping regions. When a quantity of images to be processed is dozens, or more than hundreds or thousands, this type of manual splicing process is not only cumbersome to operate but also extremely time-consuming. Furthermore, if a size of the processed images is larger, it may further increase the computational burden of the computer system, leading to decreased processing efficiency, and seriously affecting user experience and work performance. Therefore, in the field of image splicing technology, there is an urgent need for a solution that can effectively enhance processing efficiency, reduce human dependency, and overcome the difficulties of splicing large-size images to enhance the understanding and observation efficiency for the overall object appearance in different application fields, thereby optimizing the user's information acquisition experience in experimental, display, or inspection operations.

### SUMMARY

In view of this, the disclosure provides an image splicing method and an image processing device, which can be configured to solve the foregoing technical problem.

The embodiment of the disclosure provides an image splicing method, which is executed by an image processing device. The method includes: multiple images to be spliced are obtained; the multiple images to be spliced include at least one image row; a horizontal splicing procedure is performed on the multiple images to be spliced in each of the image rows to generate at least one first horizontal image corresponding to the at least one image row; the at least one first horizontal image is spliced into a first global image; a corresponding first image feature is identified in each of the first horizontal images in the first global image, and the at least one first horizontal image is accordingly calibrated into at least one corresponding second horizontal image; the at least one second horizontal image is spliced into a second global image; and a position of multiple edge images in the second global image is adjusted through executing an edge alignment procedure to generate a third global image.

The embodiment of the disclosure provides an image processing device, which includes a non-transitory storage circuit and a processor. The non-transitory storage circuit stores program code. The processor is coupled to the non-transitory storage circuit and accesses the program code to execute the following: multiple images to be spliced are obtained; the multiple images to be spliced include at least one image row; a horizontal splicing procedure is performed on the multiple images to be spliced in each of the image rows to generate at least one first horizontal image corresponding to the at least one image row; the at least one first horizontal image is spliced into a first global image; a corresponding first image feature is identified in each of the first horizontal images in the first global image, and the at least one first horizontal image is accordingly calibrated into at least one corresponding second horizontal image; the at least one second horizontal image is spliced into a second global image; and a position of multiple edge images in the second global image is adjusted by executing an edge alignment procedure to generate a third global image.

### BRIEF DESCRIPTION OF THE DRAWINGS

FIG. 1 is a schematic diagram of an image processing device according to an embodiment of the disclosure.

FIG. 2 is a flow chart of an image splicing method according to an embodiment of the disclosure.

FIG. 3 is a flow chart of a horizontal splicing procedure according to an embodiment of the disclosure.

FIG. 4A and FIG. 4B are schematic diagrams of generating a horizontal image according to a first embodiment of the disclosure.

FIG. 5 is a flow chart of generating a first global image according to an embodiment of the disclosure.

FIG. 6 is a schematic diagram of generating a first global image according to a second embodiment of the disclosure.

FIG. 7 is a flow chart of calibrating a first horizontal image into a second horizontal image according to an embodiment of the disclosure.

FIG. 8A and FIG. 8B are schematic diagrams of generating a second horizontal image according to a fourth embodiment of the disclosure.

FIG. 9 is a schematic diagram of splicing the second horizontal image into a second global image according to FIG. 8A and FIG. 8B.

FIG. 10 is a flow chart of an edge alignment procedure according to an embodiment of the disclosure.

FIG. 11 is a flow chart of a local update procedure performed on a specified edge according to a fifth embodiment of the disclosure.

### DESCRIPTION OF THE EMBODIMENTS

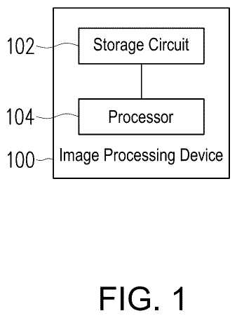

Please refer to FIG. 1, which is a schematic diagram of an image processing device according to an embodiment of the disclosure.

In the embodiment of the disclosure, an image processing device 100 refers to, for example, a system with image receiving, processing, analyzing, and output functions, which may be hardware equipment with computational processing capability, composed in conjunction with one or more software modules that execute image processing algorithms. The device may be a desktop computer, industrial computer, server, laptop computer, embedded system, or equipment mounted with an image processing chip.

In FIG. 1, the image processing device 100 includes a storage circuit 102 and a processor 104.

The storage circuit 102 is, for example, any type of fixed or movable random access memory (RAM), read-only memory (ROM), flash memory, hard disk or other similar devices or a combination of the devices, and may be configured to record multiple program codes or modules.

The processor 104 is coupled to the storage circuit 102, and may be a general-purpose processor, special-purpose processor, conventional processor, digital signal processor, multiple microprocessors, one or more microprocessors combined with digital signal processor cores, controllers, microcontrollers, application specific integrated circuit (A SIC), field programmable gate array (FPGA), any other type of integrated circuit, state machines, advanced RISC machine (ARM)-based processors and similar items.

In the embodiment of the disclosure, the processor 104 may access modules and program codes recorded in the storage circuit 102 to implement the image splicing method proposed by the disclosure. The details are described below.

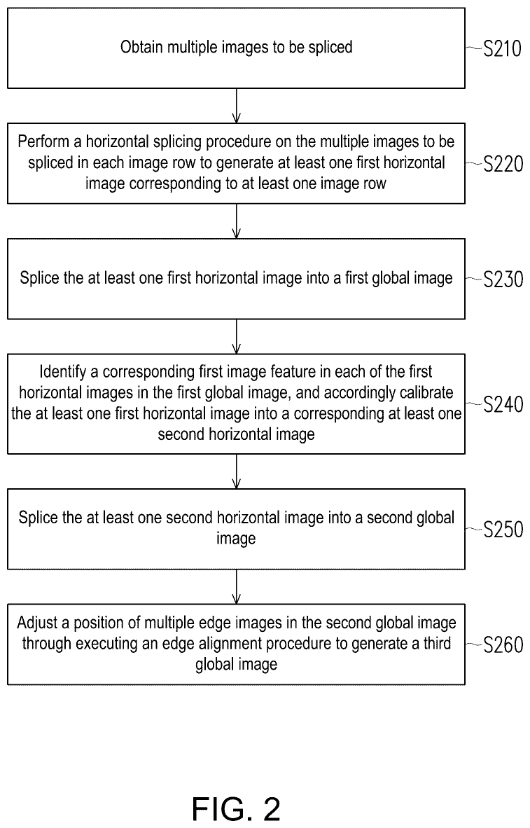

Please refer to FIG. 2, which is a flow chart of an image splicing method according to an embodiment of the disclosure. The method of the embodiment may be executed by the image processing device 100 in FIG. 1. The details of each step in FIG. 2 are described below in conjunction with the elements shown in FIG. 1.

In step S210, the processor 104 obtains multiple images to be spliced. The multiple images to be sliced include at least one image row.

In the embodiment of the disclosure, the multiple images to be sliced are, for example, obtained by a photography device performing partitioned photography on a target object. However, the disclosure is not limited thereto. In addition, the at least one image row refers to multiple images obtained by continuous photography along a predetermined direction (such as a horizontal direction, a vertical direction, or a specific trajectory). A photographic range of each image has some overlapping region to facilitate subsequent image splicing. In some embodiments, the image row may include a horizontal image sequence captured from left to right, or a vertical image sequence captured from top to bottom, and may also be extended to multiple rows of images to form an image matrix. However, the disclosure is not limited thereto.

In step S220, the processor 104 performs a horizontal splicing procedure on the multiple images to be sliced in each image row to generate at least one first horizontal image corresponding to the at least one image row.

In one embodiment, the horizontal splicing procedure refers to, for example, aligning and blending the images according to the overlapping region, feature correspondence relationship, or image coordinate information of each adjacent image in an image row to generate at least one first horizontal image corresponding to the image row.

For example, when the image row is composed of multiple images sequentially obtained from left to right by a photography device, the processor 104 may sequentially perform horizontal splicing on the images in the row, and output a spliced image as a single continuous horizontal image. In some embodiments, the processor 104 may apply algorithms such as automatic feature point matching, edge blending, exposure compensation to enhance the accuracy and naturalness of image splicing, and serve as a basis for subsequent vertical splicing or panoramic synthesis.

In one embodiment, before executing the horizontal splicing procedure, in response to determining that an image ratio of each image to be sliced is inconsistent, the processor 104 corrects the image ratio of each image to be sliced to be consistent, and executes the horizontal splicing procedure based on the multiple images to be sliced that have been corrected.

In one embodiment, the processor 104 may first determine whether the image ratio of each image to be sliced is consistent. The image ratio may include but is not limited to an aspect ratio, resolution, pixel size, or real size correspondence ratio of the image. When the processor 104 determines that there is a difference in image ratio between at least two images to be sliced, an image ratio correction procedure may be correspondingly triggered.

In one embodiment, the image ratio correction procedure may include scaling, interpolation resampling, or scale conversion operations calculated according to image capturing parameters, so that each image has a consistent ratio scale under a same splicing reference. The multiple images to be sliced that have been corrected may avoid misalignment, deformation, or overlapping errors caused by inconsistent ratios, thereby enhancing the accuracy of the subsequently executed horizontal splicing procedure and overall image quality. However, the disclosure is not limited thereto.

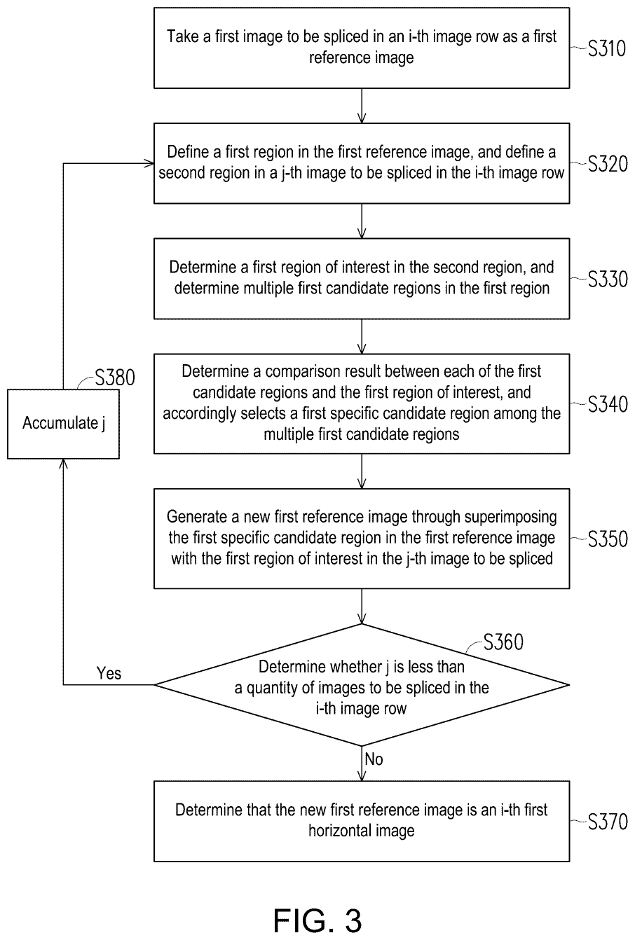

In one embodiment, the processor 104 may apply the process shown in FIG. 3 to implement step S220.

Please refer to FIG. 3, which is a flow chart of a horizontal splicing procedure according to an embodiment of the disclosure.

In the embodiment, for any one of the foregoing image rows, the processor 104 may apply the process in FIG. 3 to determine a corresponding first horizontal image. For ease of understanding, the following description takes an i-th image row (i being an index value) among the foregoing at least one image row as an example. Those skilled in the art should correspondingly understand how to determine a first horizontal image corresponding to each image row.

In step S310, the processor 104 takes a first image to be sliced in the i-th image row as a first reference image.

In step S320, the processor 104 defines a first region in the first reference image, and defines a second region in a j-th image to be sliced in the i-th image row, where j is an index value, and an initial value of j is 2.

In step S330, the processor 104 determines a first region of interest in the second region, and determines multiple first candidate regions in the first region. A size of each of the first candidate regions corresponds to the first region of interest.

In step S340, the processor 104 determines a comparison result between each of the first candidate regions and the first region of interest, and accordingly selects a first specified candidate region among the multiple first candidate regions.

In step S350, the processor 104 generates a new first reference image by superimposing the first specified candidate region in the first reference image with the first region of interest in the j-th image to be sliced.

In step S360, the processor 104 determines whether j is less than a quantity of the multiple images to be sliced in the i-th image row. If yes, the processor 104 executes step S380 to accumulate j, and returns to step S320; if no, the processor 104 executes step S370 to determine that the new first reference image is an i-th first horizontal image, which is a one corresponding to the i-th image row among the at least one first horizontal image.

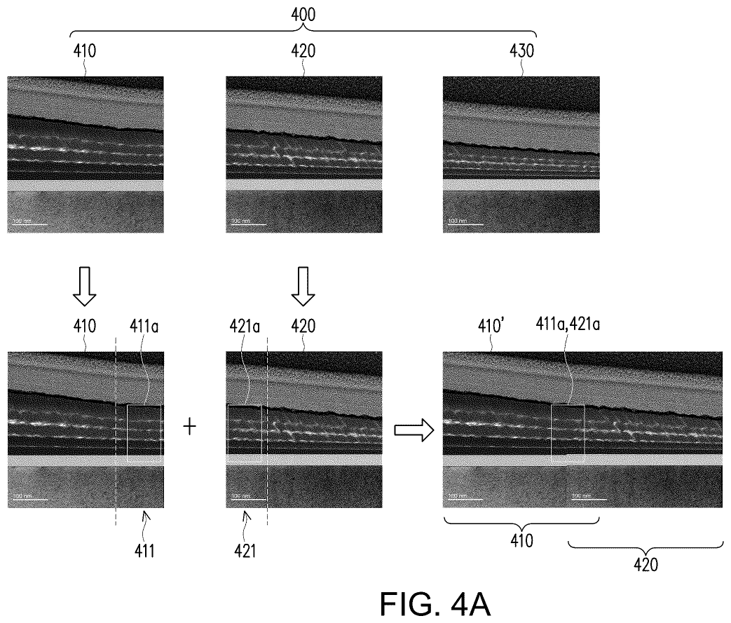

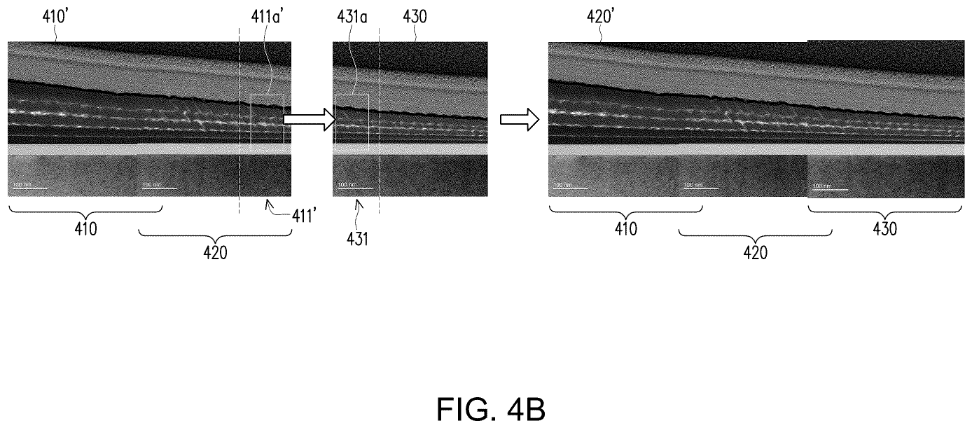

To allow the concept of FIG. 3 easier to understand, the following description is supplemented with FIG. 4A and FIG. 4B as examples. FIG. 4A and FIG. 4B are schematic diagrams of generating a horizontal image according to a first embodiment of the disclosure.

In FIG. 4A, it is assumed that images 410, 420 and 430 are images to be sliced under consideration. In this condition, it may be understood that the images to be sliced under consideration only include one image row 400. The processor 104 may apply the process in FIG. 3 to generate a corresponding first horizontal image, but this is only configured as an example and not configured to limit possible implementations.

Specifically, in step S310, the processor 104 may take a first image to be sliced in a image row 400 as a first reference image (that is, an image 410).

In step S320, the processor 104 may define a first region 411 in the first reference image (that is, the image 410).

In one embodiment, the processor 104 may, for example, determine the first region 411 according to a preset maximum overlap area ratio. The maximum overlap area ratio refers to, for example, a ratio of an overlap region to an image area of any one of two images to be sliced when the two images to be sliced are arranged in relative positions.

For example, assuming that the processor 104 needs to sequentially slice the images 410 and 420 from left to right in a scenario of FIG. 4A, the processor 104 may, for example, define the first region 411 on a right side of the image 410 according to a preset maximum overlap area ratio (such as 30%). The ratio of the area of the first region 411 to the image 410 (such as 30%) may be equal to the preset maximum overlap area ratio.

In addition, the processor 104 may define a second region in the j-th image to be sliced in the image row 400. As previously mentioned, since the initial value of j is 2, the processor 104 may define a second region 421 in a second image to be sliced in the image row 400 (that is, an image 420).

In one embodiment, the processor 104 may also determine the second region 421 according to a preset maximum overlap area ratio. For example, in the scenario of FIG. 4A, the processor 104 may, for example, define the second region 421 on a left side of the image 420 according to a preset maximum overlap area ratio (such as 30%). A ratio of the area of the second region 421 to the image 420 (such as 30%) may be equal to the preset maximum overlap area ratio.

In step S330, the processor 104 determines a first region of interest 421a in the second region 421, and determines multiple first candidate regions in the first region 411. A size of each of the first candidate regions corresponds to the first region of interest 421a.

In one embodiment, the processor 104 may, for example, determine the first region of interest 421a in the second region 421 based on a preset size and a preset relative position. For example, the processor 104 may, for example, define a rectangular region having a preset width (which is less than a width of the second region 421) and a preset height (which is less than a height of the second region 421) in the second region 421, and then take a reference position in the second region 421 (such as a center point or other reasonable position) to serve as a center point of the rectangular region, thereby determining the first region of interest 421a. However, the disclosure is not limited thereto.

In the scenario of FIG. 4A, a first candidate region 411a shown is, for example, one of the multiple first candidate regions determined by the processor 104 in step S330. Other first candidate regions (which may be distributed in the first region 411 and have a same size as the first region of interest 421a) are not individually shown to maintain the brevity of the figure.

In step S340, the processor 104 determines a comparison result between each of the first candidate regions (such as the first candidate region 411a) and the first region of interest 421a, and accordingly selects a first specified candidate region among the multiple first candidate regions.

In one embodiment, the comparison result is, for example, an image similarity. In some embodiments, the image similarity may be a value indicator configured to represent a level of similarity in image content between two image regions. For example, similarity assessment may be performed by pixel value comparison, image feature point matching, brightness or color distribution similarity, or feature vectors obtained after inference by a neural network model.

Taking the first candidate region 411a as an example, the processor 104 may determine an image similarity between the first candidate region 411a and the first region of interest 421a to serve as a comparison result between the first candidate region 411a and the first region of interest 421a. However, the disclosure is not limited thereto.

Based on the similarity principle, the processor 104 may determine the image similarity between the first region of interest 421a and each of the first candidate regions. The processor 104 may accordingly select a first specified candidate region among the multiple first candidate regions.

In one embodiment, the first specified candidate region is, for example, one that has a highest image similarity with the first region of interest 421a among the multiple first candidate regions. However, the disclosure is not limited thereto. In other embodiments, the processor 104 may also change the principle for selecting the first specified candidate region according to the designer's needs (for example, taking one that has a second highest image similarity with the first region of interest 421a among the multiple first candidate regions to serve as the first specified candidate region).

For ease of understanding, it is assumed below that the selected first specified candidate region is the first candidate region 411a shown. However, the disclosure is not limited thereto.

Next, in step S350, the processor 104 generates a new first reference image 410′ through superimposing the first specified candidate region (that is, the first candidate region 411a) in the first reference image (that is, the image 410) with the first region of interest 421a in the j-th image to be spliced (that is, the image 420).

In step S360, the processor 104 determines whether j is less than a quantity of multiple images to be spliced in the image row 400. In the scenario of FIG. 4A, since the quantity of the images 410, 420 and 430 is 3, and the current j is 2, the processor 104 may determine that j is less than the quantity of the multiple images to be spliced in the image row 400, and proceed to execute step S380 to accumulate j to 3, and then return to step S320.

For ease of understanding, the mechanism after j has been accumulated to 3 is described below with a scenario of FIG. 4B.

In FIG. 4B, when the processor 104 returns to execute step S320, the processor 104 may define a first region 411′ in the first reference image 410′, and define a second region 431 in the j-th image to be spliced (that is, the image 430) in the image row 400.

In one embodiment, the processor 104 may, for example, define the first region 411′ on a right side of the image 420 in the first reference image 410′ according to a preset maximum overlap area ratio (such as 30%). A ratio of the area of the first region 411′ to the image 420 in the first reference image 410′ (such as 30%) may be equal to the preset maximum overlap area ratio.

In addition, the processor 104 may define a second region in the j-th image to be spliced in the image row 400. Since the current value of j is 3, the processor 104 may define the second region 431 in a third image to be spliced (that is, the image 430) in the image row 400.

In one embodiment, the processor 104 may also determine the second region 431 according to a preset maximum overlap area ratio. For example, in the scenario of FIG. 4B, the processor 104 may, for example, define the second region 431 on a left side of the image 430 according to a preset maximum overlap area ratio (such as 30%). A ratio of the area of the second region 431 to the image 430 (such as 30%) may be equal to the preset maximum overlap area ratio.

In step S330, the processor 104 determines a first region of interest 431a in the second region 431, and determines multiple first candidate regions in the first region 411′. A size of each of the first candidate regions corresponds to the first region of interest 431a.

In one embodiment, the processor 104 may, for example, determine the first region of interest 431a in the second region 431 based on a preset size and a preset relative position. For example, the processor 104 may, for example, define a rectangular region having a preset width (which is less than a width of the second region 431) and a preset height (which is less than a height of the second region 431) in the second region 431, and then take a reference position in the second region 431 (such as a center point or other reasonable position) to serve as a center point of the rectangular region, thereby determining the first region of interest 431a. However, the disclosure is not limited thereto.

In the scenario of FIG. 4B, the first candidate region 411a′ shown is, for example, one of the multiple first candidate regions determined by the processor 104 in step S330. Other first candidate regions (which may be distributed in the first region 411′, and have a same size as the first region of interest 431a) are not individually shown to maintain the brevity of the figure.

In step S340, the processor 104 determines a comparison result between each of the first candidate regions (such as the first candidate region 411a′) and the first region of interest 431a, and accordingly selects a first specified candidate region among the multiple first candidate regions.

Taking the first candidate region 411a′ as an example, the processor 104 may determine an image similarity between the first candidate region 411′a and the first region of interest 431a to serve as a comparison result between the first candidate region 411a′ and the first region of interest 431a. However, the disclosure is not limited thereto.

Based on the similarity principle, the processor 104 may determine the image similarity between the first region of interest 431a and each of the first candidate regions. The processor 104 may accordingly select a first specified candidate region among the multiple first candidate regions.

In one embodiment, the first specified candidate region is, for example, one that has a highest image similarity with the first region of interest 431a among the multiple first candidate regions. However, the disclosure is not limited thereto. In other embodiments, the processor 104 may also change the principle for selecting the first specified candidate region according to the designer's needs (for example, taking one that has a second highest image similarity with the first region of interest 431a among the multiple first candidate regions to serve as the first specified candidate region).

For ease of understanding, it is assumed below that the selected first specified candidate region is the first candidate region 411a′ shown. However, the disclosure is not limited thereto.

Next, in step S350, the processor 104 generates a new first reference image 420′ through superimposing the first specified candidate region (that is, the first candidate region 411a′) in the first reference image 410′ with the first region of interest 431a in the j-th image to be spliced (that is, the image 430).

In step S360, the processor 104 determines whether j is less than the quantity of multiple images to be spliced in the image row 400. In the scenario of FIG. 4B, since the quantity of the images 410, 420 and 430 is 3, and the current j is 3, the processor 104 may determine that j is not less than the quantity of the multiple images to be spliced in the image row 400, and proceed to execute step S370 to determine that the new first reference image 420′ is a first horizontal image corresponding to the image row 400.

It should be understood that the scenarios shown in FIG. 4A and FIG. 4B is a condition where the multiple images to be spliced have only one image row.

In other embodiments, if the multiple images to be spliced under consideration have multiple image rows, the processor 104 may determine a first horizontal image corresponding to each image row based on similar principles. The details will not be repeated here.

Please refer again to FIG. 2. In step S230, the processor 104 splices the at least one first horizontal image into a first global image.

In one embodiment, the processor 104 may further perform vertical splicing on the at least one first horizontal image previously generated to form the first global image. The first horizontal image is a splicing result generated for an image row. Each horizontal image may represent a horizontal view of a target object at different vertical positions or different scanning sections.

In one embodiment, the processor 104 may utilize an overlapping region between adjacent horizontal images to perform vertical alignment and integration through feature alignment, tone balancing or other blending algorithms, ultimately generating a single continuous first global image.

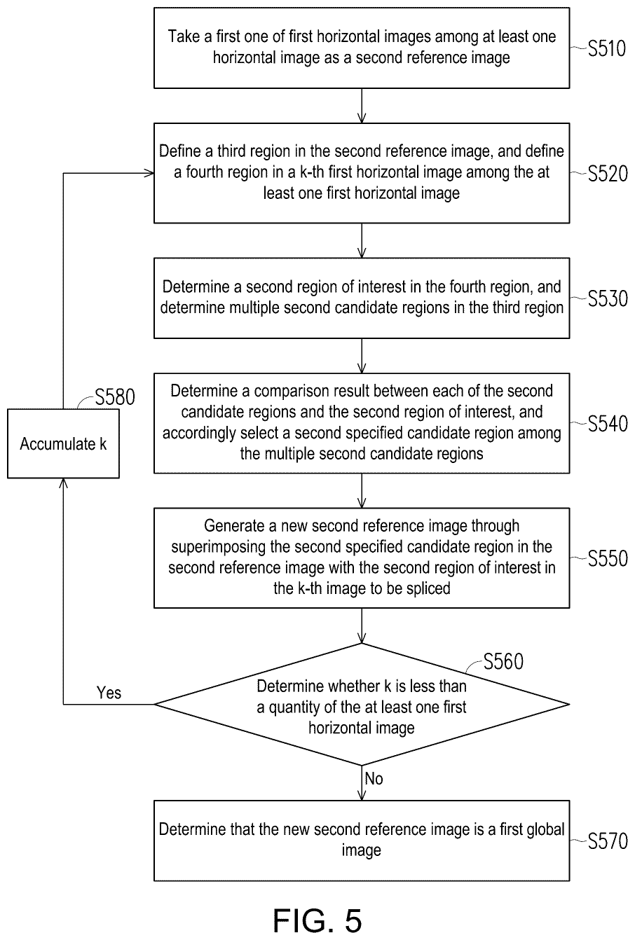

In one embodiment, the processor 104 may apply the process shown in FIG. 5 to implement step S230.

Please refer to FIG. 5, which is a flow chart of generating a first global image according to an embodiment of the disclosure.

In step S510, the processor 104 takes a first first horizontal image among the at least one horizontal image as a second reference image.

In step S520, the processor 104 defines a third region in the second reference image, and defines a fourth region in a k-th first horizontal image among the at least one first horizontal image, where k is an index value, and an initial value of k is 2.

In step S530, the processor 104 determines a second region of interest in the fourth region, and determines multiple second candidate regions in the third region. A size of each of the second candidate regions corresponds to the second region of interest.

In step S540, the processor 104 determines a comparison result between each of the second candidate regions and the second region of interest, and accordingly selects a second specified candidate region among the multiple second candidate regions.

In step S550, the processor 104 generates a new second reference image through superimposing the second specified candidate region in the second reference image with the second region of interest in the k-th image to be spliced.

In step S560, the processor 104 determines whether k is less than a quantity of the at least one first horizontal image. If yes, the processor 104 executes step S580 to accumulate k, and returns to step S520; if no, the processor 104 executes step S570 to determine that the new second reference image is the first global image.

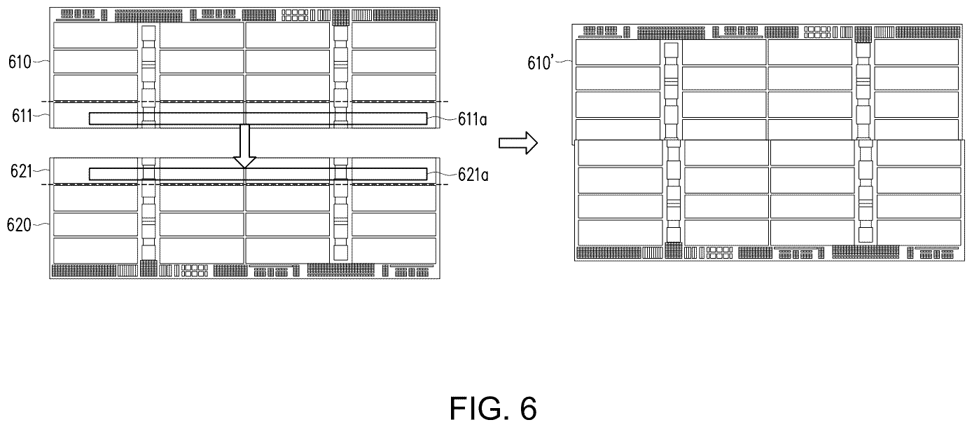

To allow the concept of FIG. 5 easier to understand, the following description is supplemented with FIG. 6 as an example. FIG. 6 is a schematic diagram of generating a first global image according to a second embodiment of the disclosure.

In FIG. 6, the multiple images to be spliced under consideration are arranged, for example, as a 2×2 image matrix. That is, the multiple images to be spliced include a total of 2 image rows. Each image row includes two images to be spliced. However, the disclosure is not limited thereto.

In the embodiment, it is assumed that the multiple images to be spliced belonging to a first image row have already been spliced into a first horizontal image 610 (which may be understood as a first first horizontal image) by the processor 104 with the previously taught mechanism. In addition, it is assumed that the multiple images to be spliced belonging to a second image row have also been spliced into a first horizontal image 620 (which may be understood as a second first horizontal image) by the processor 104 with the previously taught mechanism.

In this condition, the processor 104 may proceed to execute the process in FIG. 5 to splice the first horizontal images 610 and 620 into a first global image.

Specifically, in step S510, the processor 104 takes the first first horizontal image among the at least one horizontal image as a second reference image. That is, the processor 104 may take the first horizontal image 610 to serve as the second reference image.

In step S520, the processor 104 defines a third region 611 in the second reference image.

In one embodiment, the processor 104 may, for example, determine the third region 611 according to a preset maximum overlap area ratio. The maximum overlap area ratio refers to, for example, a ratio of an overlap region to an image area of any one of two images to be spliced when the two images to be spliced are arranged in relative positions.

For example, assuming the processor 104 needs to sequentially splice the first horizontal images 610 and 620 from top to bottom in the scenario of FIG. 6, the processor 104 may, for example, define the third region 611 at a bottom side of the first horizontal image 610 according to a preset maximum overlap area ratio (such as 30%). A ratio of the area of the third region 611 to the first horizontal image 610 (such as 30%) may be equal to the preset maximum overlap area ratio.

In addition, the processor 104 defines a fourth region in the k-th first horizontal image among the at least one first horizontal image. As previously mentioned, since the initial value of k is 2, the processor 104 may define a fourth region 621 in the second first horizontal image (that is, the first horizontal image 620).

In one embodiment, the processor 104 may also determine the fourth region 621 according to a preset maximum overlap area ratio. For example, in the scenario of FIG. 6, the processor 104 may, for example, define the fourth region 621 at a top side of the first horizontal image 620 according to a preset maximum overlap area ratio (such as 30%). A ratio of the area of the fourth region 621 to the first horizontal image 620 (such as 30%) may be equal to the preset maximum overlap area ratio.

In step S530, the processor 104 determines a second region of interest 621a in the fourth region 621, and determines multiple second candidate regions in the third region 611.

In one embodiment, the processor 104 may, for example, determine the second region of interest 621a in the fourth region 621 based on a preset size and a preset relative position. For example, the processor 104 may, for example, define a rectangular region having a preset width (which is less than a width of the fourth region 621) and a preset height (which is less than a height of the fourth region 621) in the fourth region 621, and then take a reference position (such as a center point or other reasonable position) in the fourth region 621 to serve as a center point of the rectangular region, thereby determining the second region of interest 621a. However, the disclosure is not limited thereto.

In the scenario of FIG. 6, the first candidate region 611a shown is, for example, one of the multiple second candidate regions determined by the processor 104 in step S530. Other second candidate regions (which may be distributed in the third region 611 and have a same size as the second region of interest 621a) are not individually shown to maintain the brevity of the figure.

In step S540, the processor 104 determines a comparison result between each of the second candidate regions and the second region of interest, and accordingly selects a second specified candidate region among the multiple second candidate regions.

In one embodiment, the comparison result is, for example, an image similarity as previously mentioned.

Taking the second candidate region 611a as an example, the processor 104 may determine the image similarity between the second candidate region 611a and the second region of interest 621a as a comparison result between the second candidate region 611a and the second region of interest 621a. However, the disclosure is not limited thereto.

Based on the similarity principle, the processor 104 may determine the image similarity between the second region of interest 621a and each of the second candidate regions. The processor 104 may accordingly select a second specified candidate region among the multiple second candidate regions.

In one embodiment, the second specified candidate region is, for example, the one that has a highest image similarity with the second region of interest 621a among the multiple second candidate regions. However, the disclosure is not limited thereto. In other embodiments, the processor 104 may also change the principle for selecting the second specified candidate region according to the designer's needs (for example, taking the one that has a second highest image similarity with the second region of interest 621a among the multiple second candidate regions to serve as the second specified candidate region).

For ease of understanding, it is assumed below that the selected second specified candidate region is the second candidate region 611a shown. However, the disclosure is not limited thereto.

In step S550, the processor 104 generates a new second reference image 610′ through superimposing the second specified candidate region (that is, the second candidate region 611a) in the second reference image (that is, the first horizontal image 610) with the second region of interest 621a in the k-th image to be spliced (that is, the first horizontal image 620).

In step S560, the processor 104 determines whether k is less than the quantity of the at least one first horizontal image. If yes, the processor 104 executes step S580 to accumulate k, and returns to step S520; if no, the processor 104 executes step S570 to determine that the new second reference image is the first global image.

In the scenario of FIG. 6, since the quantity of the first horizontal images 610 and 620 is 2, and the current k is 2, the processor 104 may determine that k is not less than the quantity of the at least one first horizontal image, and proceed to execute step S570 to determine that the new second reference image 610′ is the first global image.

In other embodiments, if the quantity of the at least one first horizontal image under consideration is larger (for example, greater than 2), in a condition where the current k is 2, the processor 104 may determine that k is less than the quantity of the at least one first horizontal image, and proceed to execute step S580 to accumulate k to 3, and then return to step S520. Related details may be referred to the foregoing embodiment and will not be repeated here.

In the embodiment of the disclosure, although the first global image is described as being obtained through splicing, the first global image may be understood as placing/superimposing the images to be spliced under consideration in appropriate relative positions, so that the overall appearance looks like a single image. In this condition, each of the images to be spliced in the first global image is still an independent image, and a position of each of the images to be spliced in the first global image is still adjustable/movable. In other words, although the first global image is obtained through splicing, the relative position of each of the images to be spliced is still adjustable. However, the disclosure is not limited thereto.

Please refer again to FIG. 2. In step S240, the processor 104 identifies a corresponding first image feature in a first horizontal image in the first global image, and accordingly calibrates the at least one first horizontal image into at least one corresponding second horizontal image.

In one embodiment, the processor 104 may, after completing the first global image, further perform feature identification and calibration operations for the at least one first horizontal image in the first global image. Specifically, the processor 104 may recognize a first image feature corresponding to the first horizontal image in the first global image. The first image feature may include edge segments, corner points, texture distributions, color variation regions, or other distinctive image elements.

The processor 104 may, based on a first image feature position that has been identified, determine an actual corresponding position and deformation state of the first horizontal image in the global image, and accordingly perform fine alignment and geometric calibration to calibrate the original first horizontal image into a corresponding second horizontal image. The second horizontal image may have higher alignment accuracy and may serve as a standard image data used by final image synthesis, analysis or display.

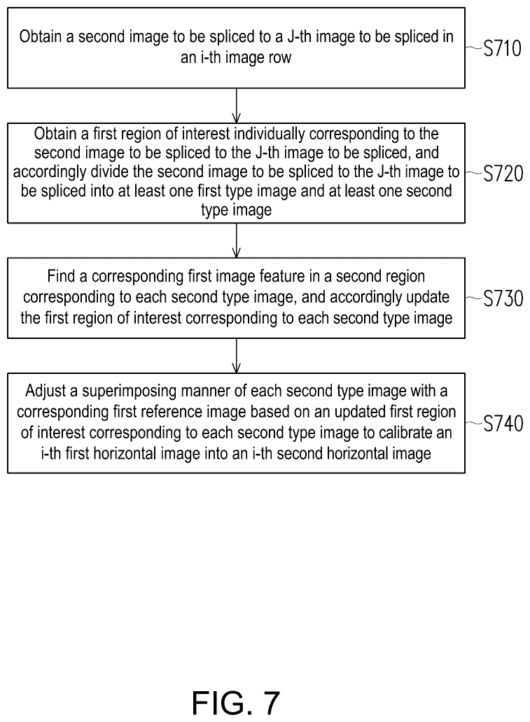

In one embodiment, the processor 104 may apply the process shown in FIG. 7 to implement step S240.

Please refer to FIG. 7, which is a flow chart of calibrating a first horizontal image into a second horizontal image according to an embodiment of the disclosure.

In step S710, the processor 104 obtains a second image to be spliced to a J-th image to be spliced in the i-th image row, where J is the quantity of the multiple images to be spliced in the i-th image row.

In step S720, the processor 104 obtains a first region of interest individually corresponding to the second image to be spliced to the J-th image to be spliced, and accordingly divides the second image to be spliced to the J-th image to be spliced into at least one first type image and at least one second type image. In one embodiment, the first region of interest corresponding to each first type image is identified to include a corresponding first image feature. The first region of interest corresponding to each second type image is identified not to include the corresponding first image feature.

In step S730, the processor 104 finds the corresponding first image feature in the second region corresponding to each second type image, and accordingly updates the first region of interest corresponding to each second type image.

In step S740, the processor 104 adjusts a superimposing manner of each second type image with the corresponding first reference image based on an updated first region of interest corresponding to each second type image to calibrate an i-th first horizontal image into an i-th second horizontal image.

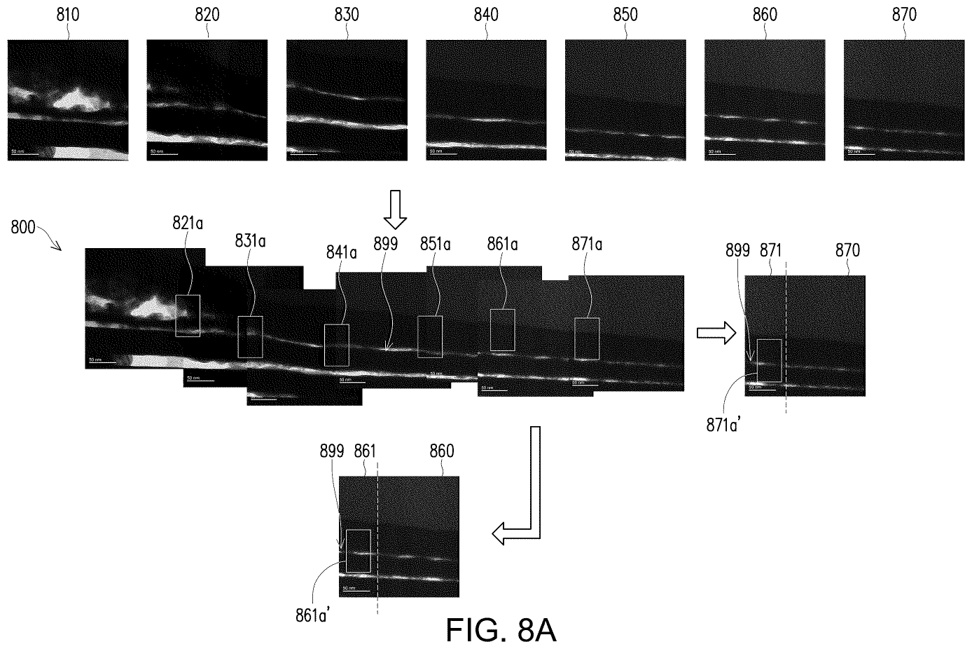

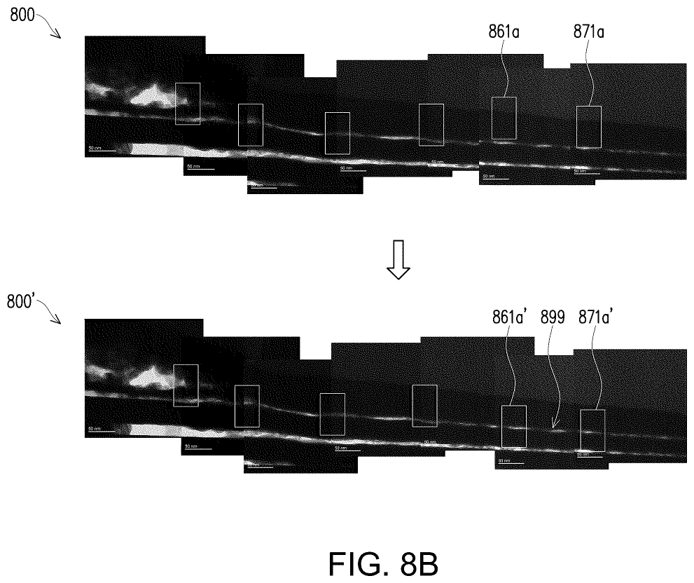

To allow the concept of FIG. 7 easier to understand, the following description is supplemented with FIG. 8A and FIG. 8B as examples. FIG. 8A and FIG. 8B are schematic diagrams of generating a second horizontal image according to a fourth embodiment of the disclosure.

In the scenario of FIG. 8A, it is assumed that the i-th image row of the multiple images to be spliced under consideration includes images 810, 820, 830, 840, 850, 860 and 870 as shown. In addition, the processor 104 has already spliced these images into a corresponding first horizontal image (that is, an i-th first horizontal image corresponding to the i-th image row) according to the teachings of previous embodiments. The first horizontal image has also been spliced with first horizontal images corresponding to other image rows to form a corresponding first global image.

In this condition, the processor 104 may correspondingly execute the process in FIG. 7 on the i-th image row shown in FIG. 8A. Specific descriptions are as follows.

In step S710, the processor 104 obtains the second image to be spliced to the J-th image to be spliced in the i-th image row. In the scenario of FIG. 8, since the i-th image row under consideration includes seven images, the value of J is 7. However, the disclosure is not limited thereto. Correspondingly, the processor 104 may obtain the images 820, 830, 840, 850, 860 and 870 in step S710.

In step S720, the processor 104 obtains the first region of interest individually corresponding to the second image to be spliced to the J-th image to be spliced, and accordingly divides the second image to be spliced to the J-th image to be spliced into at least one first type image and at least one second type image. In one embodiment, the first region of interest corresponding to each first type image is identified to include the corresponding first image feature. The first region of interest corresponding to each second type image is identified not to include the corresponding first image feature.

In the embodiment, it is assumed that the first regions of interest corresponding to the images 820, 830, 840, 850, 860 and 870 (that is, the first regions of interest determined previously when the horizontal splicing procedure is executed) are respectively first regions of interest 821a, 831a, 841a, 851a, 861a and 871a as shown. However, the disclosure is not limited thereto.

Afterwards, the processor 104 may divide the images 820, 830, 840, 850, 860 and 870 into at least one first type image and at least one second type image according to the first regions of interest 821a, 831a, 841a, 851a, 861a and 871a.

In the scenario of FIG. 8A, it is assumed that the first image feature under consideration is a line segment 899 existing in the first regions of interest 821a, 831a, 841a and 851a. However, the disclosure is not limited thereto.

In this condition, the processor 104 may determine that the images 820, 830, 840 and 850 corresponding to the first regions of interest 821a, 831a, 841a and 851a are the first type images.

In addition, since the first regions of interest 861a and 871a do not include the first image feature under consideration (such as the line segment 899), the processor 104 may determine that the images 860 and 870 corresponding to the first regions of interest 861a and 871a are the second type images.

In step S730, the processor 104 finds the corresponding first image feature in the second region corresponding to each second type image, and accordingly updates the first region of interest corresponding to each second type image.

In FIG. 8A, since the second type images under consideration are the images 860 and 870, the processor 104 may find the corresponding first image feature (such as the line segment 899) in second regions 861 and 871 (that is, the second regions determined previously when the horizontal splicing procedure is executed) respectively corresponding to the images 860 and 870.

Afterwards, the processor 104 may update the first regions of interest corresponding to the images 860 and 870 according to the first image feature in the second regions 861 and 871.

In one embodiment, the processor 104 may, for example, define a rectangular region having a preset width (which is less than a width of the second region 861) and a preset height (which is less than a height of the second region 861) in the second region 861 based on a preset size and a preset relative position, and then adjust a position of the rectangular region based on the line segment 899 in the second region 861.

For example, the processor 104 may determine a reference point on the line segment 899 in the second region 861, and then take the reference point to serve as a center point of the rectangular region, thereby determining an updated first region of interest 861a′ (which is, for example, slightly lower than the first region of interest 861a). However, the disclosure is not limited thereto.

Similarly, the processor 104 may, for example, define a rectangular region having a preset width (which is less than a width of the second region 871) and a preset height (which is less than a height of the second region 871) in the second region 871 based on a preset size and a preset relative position, and then adjust the position of the rectangular region based on the line segment 899 in the second region 871.

For example, the processor 104 may determine a reference point on the line segment 899 in the second region 871, and then take the reference point to serve as a center point of the rectangular region, thereby determining an updated first region of interest 871a′ (which is, for example, slightly lower than the first region of interest 871a). However, the disclosure is not limited thereto.

In step S740, the processor 104 adjusts the superimposing manner of each second type image with the corresponding first reference image based on the updated first region of interest corresponding to each second type image to calibrate the i-th first horizontal image to the i-th second horizontal image.

In the scenario of FIG. 8A, since the first regions of interest corresponding to the images 860 and 870 have been respectively updated to the first regions of interest 861a′ and 871a′, the processor 104 may accordingly perform the horizontal splicing procedure previously introduced. Related details may be referred to the description of the previous embodiments, which will not be repeated here.

In this way, a first horizontal image 800 shown in FIG. 8A may be calibrated into a second horizontal image 800′ as shown in FIG. 8B.

From FIG. 8B, it can be seen that since the updated first regions of interest 861a′ and 871a′ both include the corresponding first image feature (such as the line segment 899), the second horizontal image 800′ with better splicing quality may be generated.

For example, in the first horizontal image 800, the line segment 899 appears discontinuous at the splicing point due to poor splicing positions of the images 860 and 870. In comparison, in the second horizontal image 800′, the line segment 899 may provide better image quality because the related splicing positions of the images 860 and 870 have been improved.

In the fourth embodiment, the images to be spliced under consideration may also include other image rows. The processor 104 may execute the same operations on these image rows based on the related mechanisms/principles in FIG. 7, FIG. 8A, and FIG. 8B in an attempt to obtain better image quality through improving splicing positions.

Please refer to FIG. 2 again. After completing the improvement of splicing position for each image row to obtain the second horizontal image corresponding to each image row, the processor 104 may proceed to execute step S250 to slice the at least one second horizontal image into a second global image.

In one embodiment, the processor 104 may apply a mechanism similar to FIG. 5 to the at least one second horizontal image to slice the at least one second horizontal image into a corresponding second global image.

In one embodiment, although the second global image is described as being obtained through splicing, the second global image may be understood as placing/superimposing the images to be spliced in appropriate relative positions, so that the overall appearance looks like a single image. In this condition, each image to be spliced in the second global image is still an independent image, and a position of each image to be spliced in the second global image is still adjustable/movable. In other words, although the second global image is obtained through splicing, the relative position of each image to be spliced is still adjustable. However, the disclosure is not limited thereto.

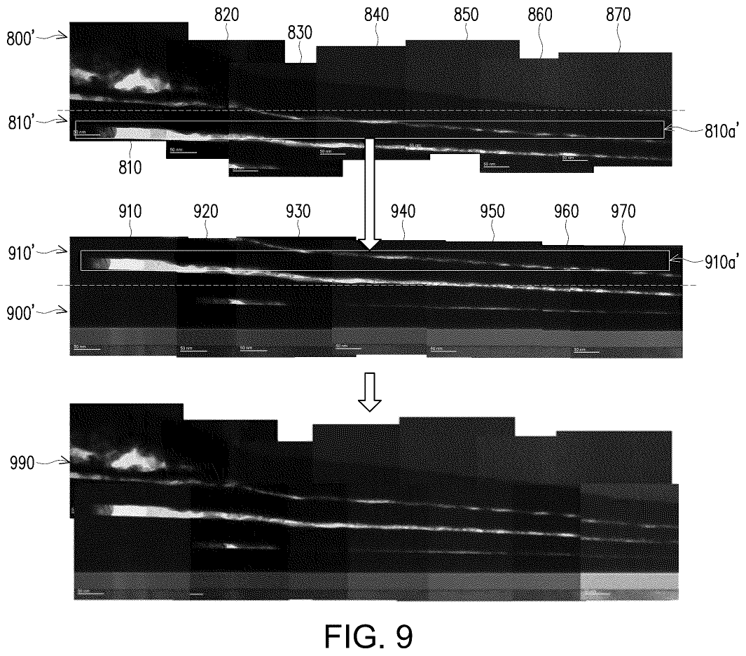

Please refer to FIG. 9, which is a schematic diagram of splicing the second horizontal image into a second global image according to FIG. 8A and FIG. 8B.

In FIG. 9, it is assumed that the images to be spliced have two image rows. A first image row includes the images 810, 820, 830, 840, 850, 860 and 870 in FIG. 8A. A second image row includes images 910, 920, 930, 940, 950, 960 and 970 as shown.

In the embodiment, it is assumed that the processor 104 has applied the mechanism shown in FIG. 7 to the first image row to generate the corresponding second horizontal image 800′.

In addition, for the second image row, the processor 104 is also assumed to have applied the mechanism shown in FIG. 7 to generate the corresponding second horizontal image 900′ (that is, the splicing positions have been improved).

In this condition, the processor 104 may execute step S250 based on the second horizontal images 800′ and 900′ to splice the second horizontal images 800′ and 900′ into a second global image 990.

As previously mentioned, the processor 104 may splice the second horizontal images 800′ and 900′ into the second global image 990 based on a mechanism similar to FIG. 5. For example, the processor 104 may define a third region 810′ in the second horizontal image 800′, and define a fourth region 910′ in the second horizontal image 900′. Afterwards, the processor 104 may define a second region of interest 910a′ in the fourth region 910′, and select a second specified candidate region (such as a second candidate region 810a′) in the third region 810′ through the previously described comparison mechanism, and then superimpose the second region of interest 910a′ with the second candidate region 810a′ to generate the corresponding second global image 990. Related details may be referred to the description of FIG. 5, which will not be repeated here.

Please refer to FIG. 2 again. After generating the second global image, the processor 104 proceeds to adjust a position of multiple edge images in the second global image through executing an edge alignment procedure in step S260 to generate a third global image.

In one embodiment, the processor 104 may further execute the edge alignment procedure for the second global image to adjust the position of the multiple edge images in the second global image. The edge images may refer to image portions located at a boundary region of the second global image, a splicing seam region, or an image portion with less overlapping range and greater alignment error during the splicing process.

The edge alignment procedure may adjust the relative position and angle through analyzing information such as geometric edge features, brightness gradients, and texture directions between the edge images and adjacent regions thereof, allowing the overall image edges to be more smooth, continuous, and natural. In some implementations, the procedure may include local deformation correction, boundary linear alignment, or utilizing optimization algorithms to minimize seam errors.

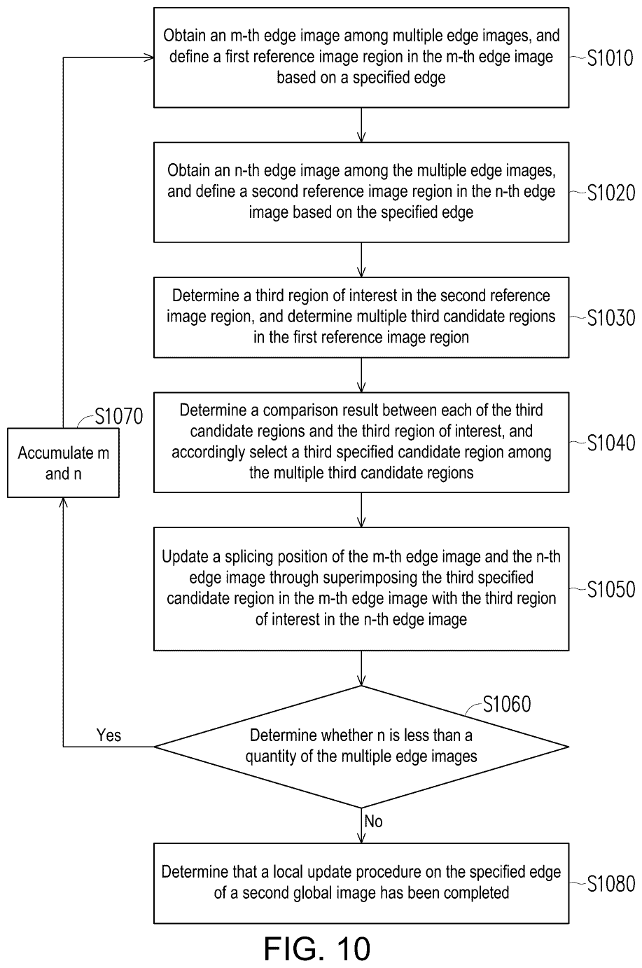

In one embodiment, the processor 104 may apply the process shown in FIG. 10 to implement step S260.

Please refer to FIG. 10, which is a flow chart of an edge alignment procedure according to an embodiment of the disclosure.

In the embodiment of the disclosure, multiple edge images are located at a specified edge of a second global image. The specified edge may be any edge of the second global image (such as a top edge, bottom edge, right edge, left edge, etc.).

In step S1010, the processor 104 obtains an m-th edge image among the multiple edge images, and defines a first reference image region in the m-th edge image based on the specified edge, where m is an index value, and an initial value of m is 1.

In step S1020, the processor 104 obtains an n-th edge image among the multiple edge images, and defines a second reference image region in the n-th reference image based on the specified edge, where n is an index value, and an initial value of n is 2.

In step S1030, the processor 104 determines a third region of interest in the second reference image region, and determines multiple third candidate regions in the first reference image region. A size of each of the third candidate regions corresponds to the third region of interest.

In step S1040, the processor 104 determines a comparison result between each of the third candidate regions and the third region of interest, and accordingly selects a third specified candidate region among the multiple third candidate regions.

In step S1050, the processor 104 updates a splicing position of the m-th edge image and the n-th edge image through superimposing the third specified candidate region in the m-th edge image with the third region of interest in the n-th edge image.

In step S1060, the processor 104 determines whether n is less than a quantity of the multiple edge images. If yes, the processor 104 proceeds to execute step S1070 to accumulate m and n, and returns to step S1010. If no, the processor 104 determines in step S1080 that a local update procedure for the specified edge of the second global image has been completed.

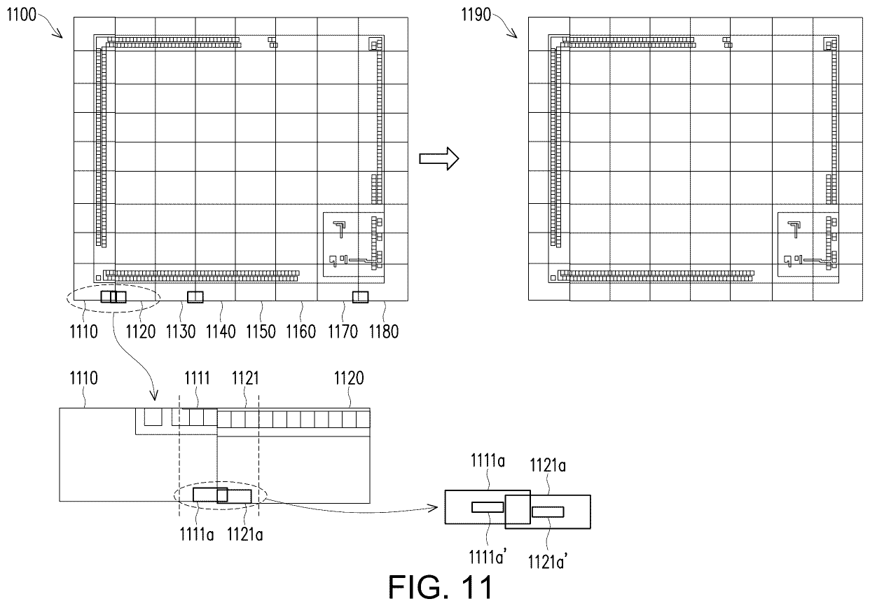

To allow the concept of FIG. 10 easier to understand, the following description is supplemented with FIG. 11 as an example. FIG. 11 is a flow chart of performing a local update procedure on a specified edge according to a fifth embodiment of the disclosure.

In the scenario of FIG. 11, it is assumed that images to be spliced under consideration are arranged as a 9×8 image matrix, and have been spliced into a second global image 1100 through various mechanisms introduced previously. In this condition, the processor 104 may regard any edge of the second global image 1100 as a specified edge, and perform a corresponding local update procedure on the specified edge.

For ease of understanding, a bottom edge of the second global image 1100 is regarded as the specific edge under consideration. Images 1110, 1120, 1130, 1140, 1150, 1160, 1170 and 1180 located at the bottom edge may be understood as the edge images under consideration. However, the disclosure is not limited thereto.

In step S1010, the processor 104 obtains an m-th edge image among the multiple edge images, and defines a first reference image region in the m-th edge image based on the specified edge, where m is an index value, and an initial value of m is 1.

In the scenario of FIG. 11, the m-th (m=1) edge image obtained by the processor 104 is, for example, the image 1110. The processor 104 may define a first reference image region 1111a in the image 1110.

In one embodiment, the processor 104 may, for example, define the first reference image region 1111a in the first region 1111 corresponding to the image 1110. The first region 1111 is determined according to the preset maximum overlap area ratio previously mentioned. Related concept may be referred to the related description of FIG. 3, which will not be repeated here.

In one embodiment, the processor 104 may, for example, determine the first reference image region 1111a according to a relative position between the specific edge under consideration and the second global image 1100. Taking FIG. 11 as an example, since the specific edge under consideration is the bottom edge, the processor 104 may, for example, determine the first reference image region 1111a to be located at the bottom of the first region 1111.

In addition, the processor 104 may determine an area ratio of the first reference image region 1111a to the first region 1111 according to a preset ratio. For ease of understanding, it is assumed below that the preset ratio is 10%. However, the disclosure is not limited thereto. In this condition, the determined first reference image region 1111a may be located at the bottom of the first region 1111, and the area is, for example, 10% of the first region 1111. However, the disclosure is not limited thereto.

In other embodiments, if the specific edge under consideration is a top/left/right edge, the processor 104 may, for example, correspondingly determine the first reference image region to be located at the top/left/right of the corresponding first region.

Furthermore, a value of the preset ratio may also be determined according to needs, and is not limited to the foregoing example.

In step S1020, the processor 104 obtains an n-th edge image among the multiple edge images, and defines a second reference image region in the n-th reference image based on the specified edge, where n is an index value, and the initial value of n is 2.

In the scenario of FIG. 11, the n-th (n is 2) edge image obtained by the processor 104 is, for example, the image 1120. The processor 104 may define a second reference image region 1121a in the image 1120.

In one embodiment, the processor 104 may, for example, define the second reference image region 1121a in the second region 1121 corresponding to the image 1120. The second region 1121 is, for example, determined according to the preset maximum overlap area ratio previously mentioned. Related concept may be referred to the related description of FIG. 3, which will not be repeated here.

In one embodiment, the processor 104 may, for example, determine the second reference image region 1121a according to a relative position between the specific edge under consideration and the second global image 1100. Taking FIG. 11 as an example, since the specific edge under consideration is the bottom edge, the processor 104 may, for example, determine the second reference image region 1121a to be located at the bottom of the second region 1121.

Furthermore, the processor 104 may determine an area ratio of the second reference image region 1121a to the second region 1121 according to a preset ratio. For ease of understanding, it is assumed below that the preset ratio is 10%. However, the disclosure is not limited thereto. In this condition, the determined second reference image region 1121a may be located at the bottom of the second region 1121, and the area is, for example, 10% of the second region 1121. However, the disclosure is not limited thereto.

In step S1030, the processor 104 determines a third region of interest 1121a′ in the second reference image region 1121a, and determines multiple third candidate regions in the first reference image region 1111a. A size of each of the third candidate regions corresponds to the third region of interest 1121a′.

In one embodiment, the processor 104 may, for example, determine the third region of interest 1121a′ in the second reference image region 1121a based on a preset size and a preset relative position. For example, the processor 104 may, for example, define a rectangular region having a preset width (which is less than a width of the second reference image region 1121a) and a preset height (which is less than a height of the second reference image region 1121a) in the second reference image region 1121a, and then take a reference position (such as a center point or other reasonable position) in the second reference image region 1121a to serve as a center point of the rectangular region, thereby determining the third region of interest 1121a′. However, the disclosure is not limited thereto.

In the scenario of FIG. 11, the third candidate region 1111a′ shown is, for example, one of the multiple third candidate regions determined by the processor 104 in step S1030. Other third candidate regions (which may be distributed in the first reference image region 1111a and have a same size as the third region of interest 1121a′) are not individually shown to maintain the brevity of the figure.

In step S1040, the processor 104 determines a comparison result between each of the third candidate regions and the third region of interest 1121a′, and accordingly selects a third specified candidate region among the multiple third candidate regions.

In one embodiment, the comparison result is, for example, an image similarity previously mentioned.

Taking the third candidate region 1111a′ as an example, the processor 104 may determine the image similarity between the third candidate region 1111a′ and the third region of interest 1121a′ as a comparison result between the third candidate region 1111a′ and the third region of interest 1121a′. However, the disclosure is not limited thereto.

Based on the similarity principle, the processor 104 may determine the image similarity between the third region of interest 1121a′ and each of the third candidate regions. The processor 104 may accordingly select a third specified candidate region among the multiple third candidate regions.

In one embodiment, the third specified candidate region is, for example, the one that has a highest image similarity with the third region of interest 1121a′ among the multiple third candidate regions. However, the disclosure is not limited thereto. In other embodiments, the processor 104 may also change the principle for selecting the third specified candidate region according to the designer's needs (for example, taking the one that has a second highest image similarity with the third region of interest 1121a′ among the multiple third candidate regions to serve as the third specified candidate region).

For ease of understanding, it is assumed below that the selected third specified candidate region is the third candidate region 1111a′ shown. However, the disclosure is not limited thereto.

In step S1050, the processor 104 updates a splicing position of the m-th edge image and the n-th edge image through superimposing the third specified candidate region (such as the third candidate region 1111a′) in the m-th edge image with the third region of interest 1121a′ in the n-th edge image.

In step S1060, the processor 104 determines whether n is less than the quantity of the multiple edge images. In the scenario of FIG. 11, since the quantity of the images 1110, 1120, 1130, 1140, 1150, 1160, 1170 and 1180 is 8, and the current n is 2, the processor 104 may determine that n is not less than the quantity of the multiple edge images, and proceed to execute step S1080 to accumulate m and n, and return to step S1010.

After m and n are accumulated, the current values of m and n are respectively 2 and 3, so the processor 104 may correspondingly regard the images 1120 and 1130 as the m-th edge image in step S1010 and the n-th edge image in step S1020. Afterwards, the processor 104 may repeatedly execute steps S1010 to S1070 according to the previously introduced mechanism to adjust the splicing positions between adjacent images in the images 1120, 1130, 1140, 1150, 1160, 1170 and 1180, until n is accumulated to be not less than the quantity of the multiple edge images.

In one embodiment, when n is accumulated to be not less than the quantity of the multiple edge images, the processor 104 may, after executing step S1060, proceed to execute step S1080 to determine that a local update procedure on the specified edge (such as the bottom edge) of the second global image 1100 has been completed.

In the embodiment of the disclosure, the processor 104 may execute a corresponding local update procedure for each edge of the second global image 1100 to generate a third global image 1190. However, the disclosure is not limited thereto.

In summary, the image splicing method proposed in the embodiment of the disclosure can effectively solve the problems in existing technology where images need to be manually spliced with cumbersome processing and low efficiency. Through automatically executing procedures such as image ratio correction, feature alignment, horizontal and vertical splicing, the disclosure can significantly enhance the processing efficiency of large amounts of image data, significantly reduce the need for manual operation, and is adapted to splicing applications for high-resolution or large-size images with high scalability and system computational efficiency.

In addition, the disclosure can enhance image alignment accuracy and seam smoothness by feature-oriented splicing technology and edge optimization mechanism, further enhancing the overall quality and visual continuity of panoramic images. The integrated global image facilitates users to quickly understand the complete appearance of large samples or mechanisms, enhancing information visualization effects in experimental observation, inspection interpretation, or display applications with practicality and industrial application value.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. An image splicing method, executed by an image processing device, comprising:
obtaining a plurality of images to be spliced, wherein the plurality of images to be spliced comprise at least one image row;
performing a horizontal splicing procedure on the plurality of images to be spliced in each of the image rows to generate at least one first horizontal image corresponding to the at least one image row;
splicing the at least one first horizontal image into a first global image;
identifying a corresponding first image feature in each of the first horizontal images in the first global image, and accordingly calibrating the at least one first horizontal image into at least one corresponding second horizontal image;
splicing the at least one second horizontal image into a second global image; and
adjusting a position of a plurality of edge images in the second global image through executing an edge alignment procedure to generate a third global image.

2. The method according to claim 1, wherein the at least one image row comprises an i-th image row, the at least one first horizontal image comprises an i-th first horizontal image corresponding to the i-th image row, and for the i-th image row, the horizontal splicing procedure comprises:
(a1) taking a first image to be spliced in the i-th image row as a first reference image;
(a2) defining a first region in the first reference image, and defining a second region in a j-th image to be spliced in the i-th image row, wherein i and j are index values, and an initial value of j is 2;
(a3) determining a first region of interest in the second region, and determining a plurality of first candidate regions in the first region, wherein a size of each of the first candidate regions corresponds to the first region of interest;
(a4) determining a comparison result between each of the first candidate regions and the first region of interest, and accordingly selecting a first specified candidate region among the plurality of first candidate regions;
(a5) generating a new first reference image through superimposing the first specified candidate region in the first reference image with the first region of interest in the j-th image to be spliced; and
(a6) determining whether j is less than a quantity of the plurality of images to be spliced in the i-th image row;
accumulating j and returning to step (a2) in response to determining that j is less than the quantity of the plurality of images to be spliced in the i-th image row;
determining that the new first reference image is the i-th first horizontal image in response to determining that j is not less than the quantity of the plurality of images to be spliced in the i-th image row.

3. The method according to claim 1, wherein the at least one image row comprises an i-th image row, the at least one first horizontal image comprises an i-th first horizontal image corresponding to the i-th image row, and splicing the at least one first horizontal image into the first global image comprises:
(b1) taking a first one of the first horizontal images in the at least one horizontal image as a second reference image;
(b2) defining a third region in the second reference image, and defining a fourth region in a k-th first horizontal image from the at least one first horizontal image, wherein i and k are index values, and an initial value of k is 2;
(b3) determining a second region of interest in the fourth region, and determining a plurality of second candidate regions in the third region, wherein a size of each of the second candidate regions corresponds to the second region of interest;
(b4) determining a comparison result between each of the second candidate regions and the second region of interest, and accordingly selecting a second specified candidate region among the plurality of second candidate regions;
(b5) generating a new second reference image by superimposing the second specified candidate region in the second reference image with the second region of interest in the k-th image to be spliced; and
(b6) determining whether k is less than a quantity of the at least one first horizontal image;
accumulating k and returning to step (b2) in response to determining that k is less than the quantity of the at least one first horizontal image;
determining that the new second reference image is the first global image in response to determining that k is not less than the quantity of the at least one first horizontal image.

4. The method according to claim 2, wherein the at least one second horizontal image comprises an i-th second horizontal image corresponding to the i-th first horizontal image, and identifying the corresponding first image feature in each of the first horizontal images in the first global image, and accordingly calibrating the at least one first horizontal image into the at least one corresponding second horizontal image comprises:
(c1) obtaining a second image to be spliced to a J-th image to be spliced in the i-th image row, wherein J is the quantity of the plurality of images to be spliced in the i-th image row;
(c2) obtaining first regions of interest individually corresponding to the second image to be spliced to the J-th image to be spliced, and accordingly dividing the second image to be spliced to the J-th image to be spliced into at least one first type image and at least one second type image, wherein the first region of interest corresponding to each of the first type images is identified to comprise the corresponding first image feature, and the first region of interest corresponding to each of the second type images is identified not to comprise the corresponding first image feature;
(c3) finding the corresponding first image feature in the second region corresponding to each of the second type images, and accordingly updating the first region of interest corresponding to each of the second type images; and
(c4) adjusting a superimposing manner of each of the second type images and the corresponding first reference image based on an updated first region of interest corresponding to each of the second type images to calibrate the i-th first horizontal image into the i-th second horizontal image.

5. The method according to claim 1, wherein the plurality of edge images are located at a specified edge of the second global image, and the edge alignment procedure comprises:
(d1) obtaining an m-th edge image among the plurality of edge images, and defining a first reference image region in the m-th edge image based on the specified edge, wherein m is an index value, and an initial value of m is 1;
(d2) obtaining an n-th edge image among the plurality of edge images, and defining a second reference image region in the n-th reference image based on the specified edge, wherein n is an index value, and an initial value of n is 2;
(d3) determining a third region of interest in the second reference image region, and determining a plurality of third candidate regions in the first reference image region, wherein a size of each of the third candidate regions corresponds to the third region of interest;
(d4) determining a comparison result between each of the third candidate regions and the third region of interest, and accordingly selecting a third specified candidate region among the plurality of third candidate regions;
(d5) updating a splicing position of the m-th edge image and the n-th edge image through superimposing the third specified candidate region in the m-th edge image with the third region of interest in the n-th edge image;
(d6) determining whether n is less than a quantity of the plurality of edge images;
accumulating m and n and returning to step (d1) in response to determining that n is less than the quantity of the plurality of edge images;
determining that a local update procedure of the specified edge of the second global image has been completed in response to determining that n is not less than the quantity of the plurality of edge images.

6. The method according to claim 5, wherein the second global image comprises a plurality of edges, and the edge alignment procedure further comprises:
completing the local update procedure corresponding to each of the edges to determine the third global image.

7. The method according to claim 1, further comprising:
correcting an image ratio of each of the images to be spliced to be consistent in response to determining that the image ratio of each of the images to be spliced is inconsistent before executing the horizontal splicing procedure, and executing the horizontal splicing procedure based on the plurality of images to be spliced that have been corrected.

8. An image processing device, comprising:
a non-transitory storage circuit, storing program code; and
a processor, coupled to the non-transitory storage circuit and accessing the program code to:
obtain a plurality of images to be spliced, wherein the plurality of images to be spliced comprise at least one image row;
perform a horizontal splicing procedure on the plurality of images to be spliced in each of the image rows to generate at least one first horizontal image corresponding to the at least one image row;
splice the at least one first horizontal image into a first global image;
identify a corresponding first image feature in each of the first horizontal images in the first global image, and accordingly calibrate the at least one first horizontal image into at least one corresponding second horizontal image;
splice the at least one second horizontal image into a second global image; and
adjust a position of a plurality of edge images in the second global image through executing an edge alignment procedure to generate a third global image.
